(19) United States
(12) Patent Application Publication
(10) Pub. No.: US 2004/0247151 A1
(43) Pub. Date: Dec. 9, 2004

(54) Automobile sound system

(76) Inventor: Keith L. Smith, Philadelphia, PA (US)

Correspondence Address: PAUL AND PAUL, 2900 TWO THOUSAND MARKET STREET, PHILADELPHIA, PA, 19103, US

(21) Appl. No.: 10/862,523

(22) Filed: Jun. 7, 2004

Related U.S. Application Data
(60) Provisional application No. 60/476,862, filed on Jun. 6, 2003.

(51) Int. Cl. H04R 1/02; H04R 5/02

(52) U.S. Cl. 381/389; 381/302; 381/86

(57) ABSTRACT

An automobile sound system includes a speaker, an enclosure for mounting the speaker, and a spaced deflector plate positioned in front of the speaker. The deflector plate is mounted to permit the deflector plate to move asymmetrically in response to the speaker.

### BACKGROUND OF THE INVENTION

The present invention relates to the field of automobile sound systems.

Sound systems for automobiles are well-known, and a large variety of specially adapted equipment including speakers, radios, compact disc players, amplifiers, and the like is available both in OEM and after-market versions. Systems can be customized to suit the owner's aesthetic preferences, in terms of both sound characteristics and appearance.

One portion of the market for automobile sound systems values systems that can deliver deep, loud bass tones, often employed in hip-hop, rock and roll, and other music.

Automobile sound systems for delivering deep, loud bass tones often include subwoofer speakers mounted at the rear of the passenger compartment, and extending into the trunk space. A problem frequently encountered with such system is distracting noise cause by rattling of portions of the auto and/or the trunk contents.

Thus, there is a continuing need for automobile sound systems that can deliver deep, loud bass tones while reducing undesirable noise.

### SUMMARY OF THE INVENTION

The present invention is directed to an automobile sound system that can deliver deep, loud bass tones, while reducing undesired noise. The automobile sound system comprises a speaker, preferably a subwoofer, an enclosure for mounting the speaker, and a spaced deflector plate positioned in front of the speaker. The deflector plate is mounted to the enclosure in front of the speaker, and is mounted to permit the deflector plate to move asymmetrically responsive to the speaker.

In a presently preferred embodiment of the present invention, it is preferred that the enclosure include a generally cylindrical cover having a first end and a second end, a generally circular base plate attached to the first end of the cover, and a generally circular, annular speaker ring attached to the second end of the cover, the speaker being mounted within the speaker ring. Preferably, the cover includes damping material adhered to the interior surface of the cover.

It is also preferred that the deflector plate is generally circular, and that the automobile sound system includes at least one rail mounted to the exterior of the enclosure, with the deflector plate being mounted on the at least one rail.

Preferably, the automobile sound system further includes visual indication means for providing a visual indication of the electrical current being delivered to the speaker. Preferably, the visual indication means includes at least one light-emitting device, such as an LED, powered by current applied to the speaker coil. It is also preferred that the automobile sound system includes a fuse for protecting the speaker against excessive current.

### BRIEF DESCRIPTION OF THE DRAWINGS

FIG. 1 is a schematic sectional side view of an automobile sound system according to the present invention.

FIG. 2 is schematic sectional side view of the automobile sound system of FIG. 1 showing the major components thereof.

FIG. 3 is a rear elevational view of the automobile sound system of FIG. 1.

### DETAILED DESCRIPTION OF THE PREFERRED EMBODIMENT

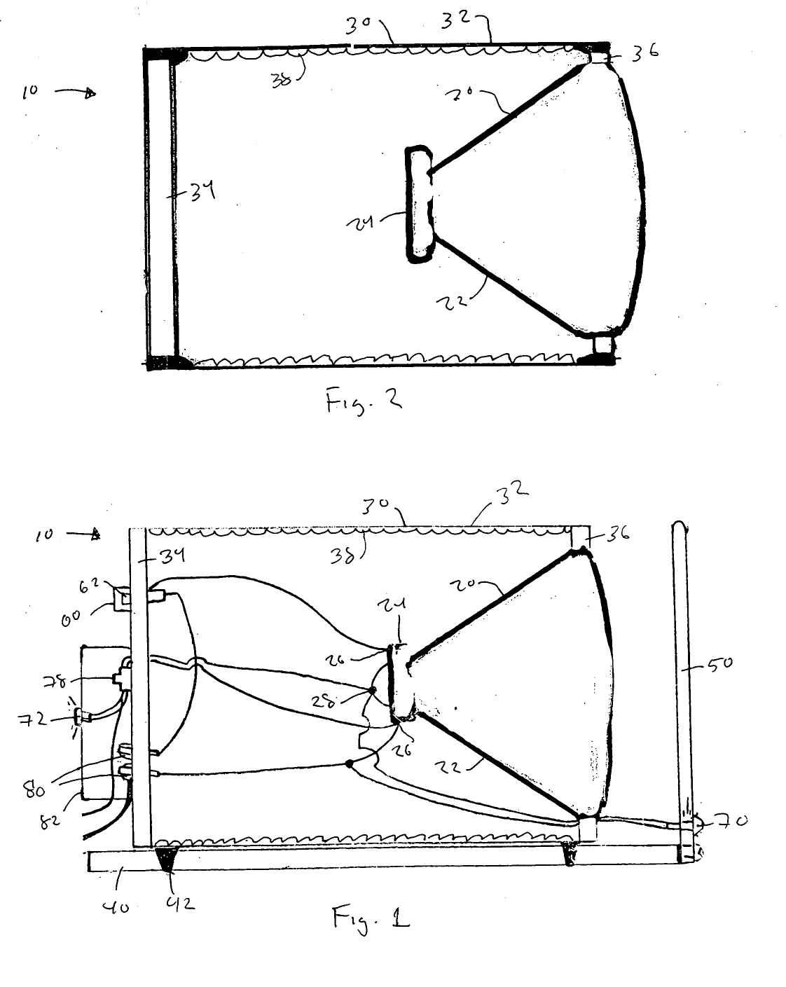

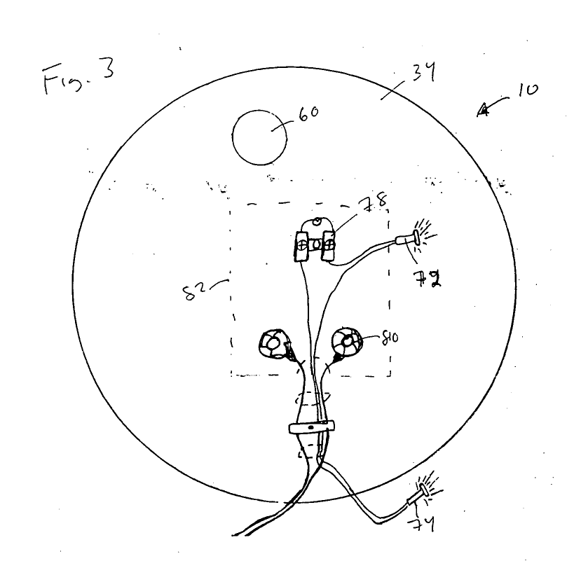

Referring now to the drawings in detail, wherein like reference numerals indicate like elements through the several views, there is shown in FIG. 1, a schematic sectional view of presently preferred embodiment of an automobile sound system 10 according to the present invention. The automobile sound system 10 is adapted for mounting in the trunk or rear seat area of an automobile, truck, or other vehicle (not shown). The automobile sound system 10 includes a subwoofer 20 having a speaker cone 22 and speaker coil 24 from which extend coil terminals 26 for connecting the speaker coil 24 to the output section of a suitable audio amplifier (not shown).

The subwoofer 28 is mounted in a sealed enclosure 30, the enclosure 30 including a generally cylindrical cover 32 which is securely attached to a solid back end or base plate 34, as well as a rigid, preferably wooden, speaker ring 36 that encircles and is securely attached to the outer end of the speaker cone 22. The speaker ring 36 is sized to fit within the interior of the cover 32 proximate one end thereof. The speaker ring 36 is preferably made from a rigid material such as medium density fiberboard (“MDF”). The speaker ring 36 is preferably rigidly mounted to the inside of the cover 32 using adhesive, preferably MDF adhesive. The interior surface of the cover 32 is covered with a suitable damping material or padding 38, the padding 38 being adhered to the interior surface of the cover 32 using a suitable adhesive material.

The enclosure 30 is mounted on a pair of rails 40 by means of feet 42 that extend from the bottom of the enclosure 30. A generally circular deflector or “pound” plate 50 is mounted on the rails 40 at a fixed spacing, preferably about two to three inches from the front of the enclosure 30. The deflector plate 50 is preferably fashioned from a sturdy transparent or translucent plastic material or “plastic glass,” such as poly methyl methacrylate or polycarbonate, and can be suitably decorated.

The deflector plate 50 is not attached to the top of the enclosure 30, advantageously providing less “trunk” noise or rattle. The deflector plate 50 is mounted so that the deflector plate 50 can move or vibrate asymmetrically responsive to the subwoofer output. In the simplest vibrational mode, the top end of the deflector plate 50 moves back and forth while the bottom end of the deflector plate remains fixed (not shown).

The automobile sound system 10 of the present invention also includes a fuse holder 60 and fuse 62 and an active subwoofer sensor unit 70.

The fuse holder 60 is mounted in a suitable aperture in the base plate 34. One terminal of the fuse holder 60 is connected to one of the two speaker coil terminals 26, and the other terminal of the fuse holder 60 is connected to one of two external speaker “T” terminals 80 also mounted in suitable apertures in the base 34 for connection to an audio subwoofer amplifier (not shown). The other of the two speaker coil terminals 26 is connected directly to other external speaker “T” terminal 80.

The fuse holder 60 permits the installer a simple means for matching the output power of the audio amplifier being used to the power drawn by the subwoofer 20. A peak music signal at peak volume is fed to the subwoofer through a fuse 62 having a high capacity rating, such as ten (10) amps. The high capacity fuse is then replaced with a fuse having a somewhat smaller capacity, and the time required to melt the fuse is measured. If the fuse “blows” in five seconds or less, the woofer is overpowered. If the timer required to melt the fuse is five seconds or more, the woofer is suitably powered. The greater the time required to melt the fuse, the better.

The active subwoofer sensor unit 70 preferably includes a plurality of LED connected in parallel between one of the speaker coil terminals 26 and a speaker coil tap 28. Preferably, a first LED 70 is mounted in the deflector plate 50, while a second LED 72 is mounted in a protective cover 82 fastened to the back of the base plate 34 and covering the “T” terminals 80 (shown in phantom in FIG. 3). A power strip 78 is provided on the base plate 34 for connecting the second LED 72 to the speaker terminal and tap. A third LED 74 is connected though the power strip 78 and through a low profile cable for mounting proximate the driver of the vehicle (not shown). The speaker tap is chosen so that the LEDs 72, 74, 76 illuminate when the subwoofer 20 is being powered, over a wide range of input voltages. If the LEDs do not illuminate, the driver has an indication that the speaker coil is not operating. Random or irregular illumination of the LED is symptomatic of a damaged coil, requiring attention or replacement.

It will be recognized by those skilled in the art that changes may be made by the above-described embodiments of the invention without departing from the broad inventive concepts thereof. For example, each of the features described above do not all need to be included in a single device. Rather, one or more features can be provided in a single device where desired and in any combination. It is understood, therefore, that this invention is not limited to the particular embodiment disclosed, but it is intended to cover all modifications, which are within the scope and spirit of the invention.

I claim:

1. An automobile sound system comprising:
a speaker;
an enclosure for mounting the speaker; and
a spaced deflector plate positioned in front of the speaker, the deflector plate being mounted to the enclosure, the deflector plate being mounted to permit the deflector plate to move asymmetrically responsive to the speaker.

2. An automobile sound system according to claim 1 wherein the enclosure includes a generally cylindrical cover having a first end and a second end, a generally circular base plate attached to the first end of the cover, and a generally circular, annular speaker ring attached to the second end of the cover, the speaker being mounted within the speaker ring.

3. An automobile sound system according to claim 2 wherein the cover includes damping material adhered to the interior surface of the cover.

4. An automobile sound system according to claim 1 wherein the deflector plate is generally circular.

5. An automobile sound system according to claim 2 further including at least one rail mounted to the exterior of the enclosure, the deflector plate being mounted on the at least one rail.

6. An automobile sound system according to claim 1 further including visual indication means for providing a visual indication of the electrical current being delivered to the speaker.

7. An automobile sound system according to claim 6 wherein the visual indication means includes at least one light emitting device powered by current applied to the speaker coil.

8. An automobile sound system according to claim 1 further include a fuse for protecting the speaker against excessive current.

9. An automobile sound system according to claim 1 wherein the speaker is a subwoofer.
